(19) United States
(12) Patent Application Publication
(10) Pub. No.: US 2009/0254879 A1
(43) Pub. Date: Oct. 8, 2009

(54) METHOD AND SYSTEM FOR ASSURING DATA INTEGRITY IN DATA-DRIVEN SOFTWARE

(76) Inventors: Derek Foster, Sunnyvale, CA (US); Stephen Daly, Morgan Hill, CA (US); Lori Yoshida, Cupertino, CA (US); Graeme Cox, Vancouver (CA)

Correspondence Address: MCANDREWS HELD & MALLOY, LTD, 500 WEST MADISON STREET, SUITE 3400, CHICAGO, IL, 60661, US

(21) Appl. No.: 12/099,278

(22) Filed: Apr. 8, 2008

(51) Int. Cl. G06F 9/44

(52) U.S. Cl. 717/106

(57) ABSTRACT

Described herein is a system and method for developing data-driven software, which references coded values. Coded values may include resource identifiers such as icons, bitmaps, localized strings, menus, screens, and sounds. According to certain aspects of the present invention, a build process is presented that creates a robust way for data to refer to coded values using XML together with document type entity definitions (DTD entity values). According to certain aspects of the present invention, systems and methods are presented for assuring data integrity in the data-driven software.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Computer software may be written in many different programming languages and may exist on different application domains. Software design methodologies may be completely different in different environments and application domains. For example, data-driven software may be written in a high-level language and may use entity-relationships to model data. Data-driven software may be well suited for applications where new programs must be backwards compatible with legacy programs and data files.

Limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Described herein are system(s) and method(s) for assuring data integrity in data-driven software, substantially as shown in and/or described in connection with at least one of the figures, as set forth more completely in the claims.

These and other advantages and novel features of the present invention will be more fully understood from the following description.

### BRIEF DESCRIPTION OF THE DRAWINGS

FIG. 1 is a flow diagram that illustrates a method for assuring data integrity in data-driven software in accordance with an embodiment of the present invention;

FIG. 2A is an exemplary source C++ header file in accordance with an embodiment of the present invention;

FIG. 2B is an exemplary list of DTD entity definitions in accordance with an embodiment of the present invention;

FIG. 3A is another exemplary list of DTD entity definitions in accordance with an embodiment of the present invention;

FIG. 3B is an exemplary XML file in accordance with an embodiment of the present invention;

FIG. 4 is an exemplary XML output in accordance with an embodiment of the present invention;

FIG. 5A is an exemplary build rule in accordance with an embodiment of the present invention;

FIG. 5B is an exemplary build target definition in accordance with an embodiment of the present invention;

FIG. 5C is an exemplary compiler conditional directive in accordance with an embodiment of the present invention; and

FIG. 6 is a block diagram of a system for assuring data integrity in data-driven software in accordance with an embodiment of the present invention.

### DETAILED DESCRIPTION OF THE INVENTION

In data-driven software, there is a need for data to refer to coded values. Coded values may include resource identifiers such as icons, bitmaps, localized strings, menus, screens, and sounds. According to certain aspects of the present invention, a build process is presented that creates a robust way for data to refer to coded values using XML together with document type entity definitions (DTD entity values). According to certain aspects of the present invention, systems and methods are presented for assuring data integrity in data-driven software.

The build process may generate DTD entity values from C++ header files. XML software may then refer to these DTD entity values. This method may ensure that every identifier in a data file also exists as an identifier in the C++ code. Furthermore, each data file identifier may be mapped to a C++ code identifier.

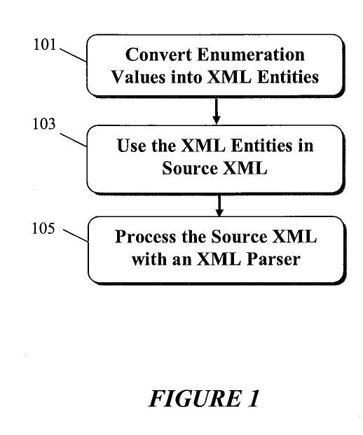

FIG. 1 is a flow diagram that illustrates a method for assuring data integrity in data-driven software in accordance with an embodiment of the present invention. At 101, enumeration values are converted to XML entities.

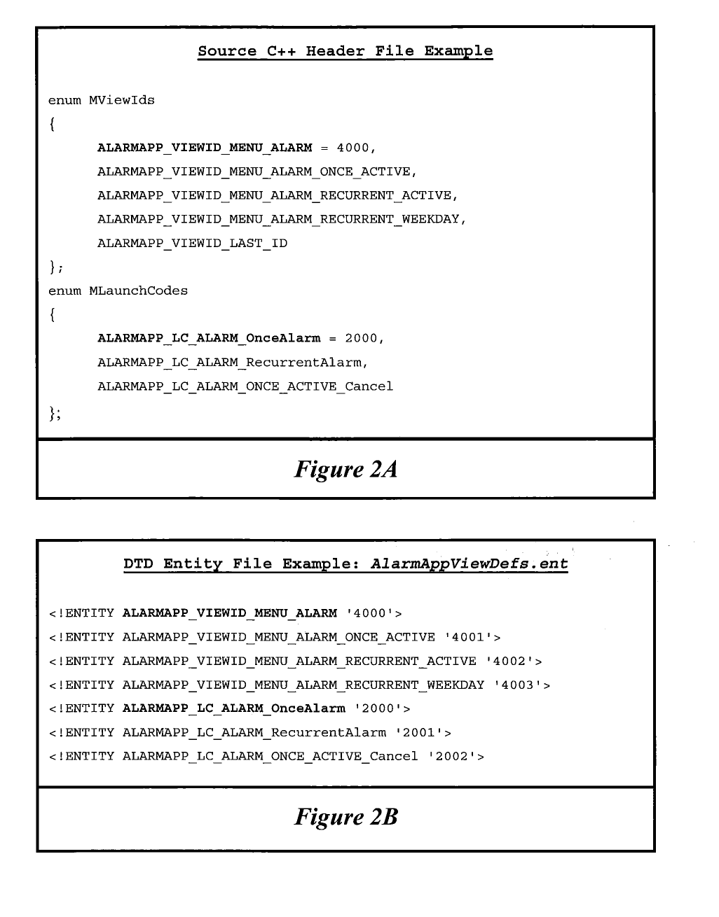

Referring now to FIG. 2A, an exemplary source C++ header file is shown. In this file, an exemplary enumeration value is “ALARMAPP_VIEWID_MENU_ALARM.” Given this header file content shown in FIG. 2A, a build tool may generate the DTD entity definitions shown in FIG. 2B. The exemplary enumeration value, “ALARMAPP_VIEWID_MENU_ALARM,” has been converted to the XML entity, “ALARMAPP_VIEWID_MENU_ALARM.”

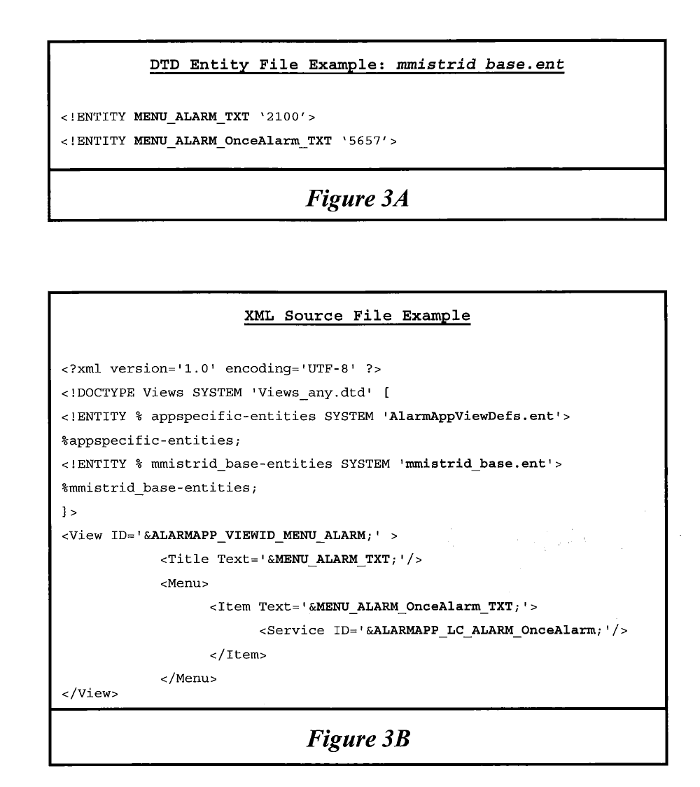

At 103 in FIG. 1, the XML entities may be used in source XML code. For example, entity files (such as those in FIG. 2B) plus any other relevant definitions (such as those in FIG. 3A) are referred to in the source XML file shown in FIG. 3B.

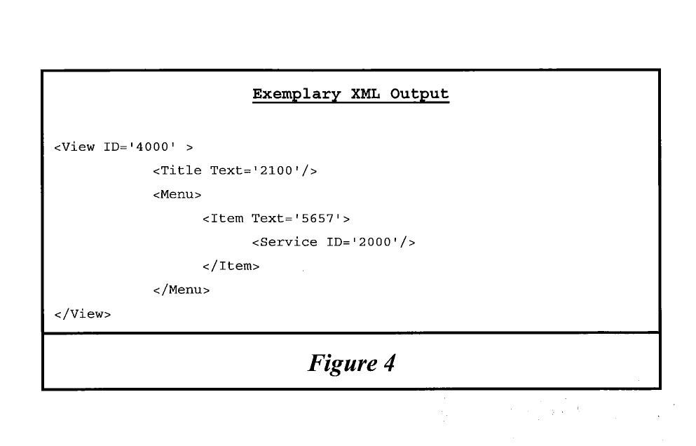

At 105 in FIG. 1, the source XML code may be processed. The processing may be performed by an XML parser. For example, the source XML in FIG. 3B may be processed by an XML parser to produce the resulting XML output shown in FIG. 4. The XML output of FIG. 4 possesses the same values as the C++ code as a result of an automated build process. The XML output may be reliably integrated with other code at runtime. If any identifier in the source XML file is not defined by an entity file, the process may fail with an error and no output XML file is created, thereby avoiding the risk of encountering an incomplete XML output file or undefined identifier at runtime.

The build procedure may be implemented using XML processing, makefiles, and perl scripts. By using the “make” rule, processing may be performed on only the files that have changed, thereby saving time and providing a way to confirm that output files are up to date. The dependency of XML files on entity files and the dependency of entity files on header files may be automatically extracted and maintained.

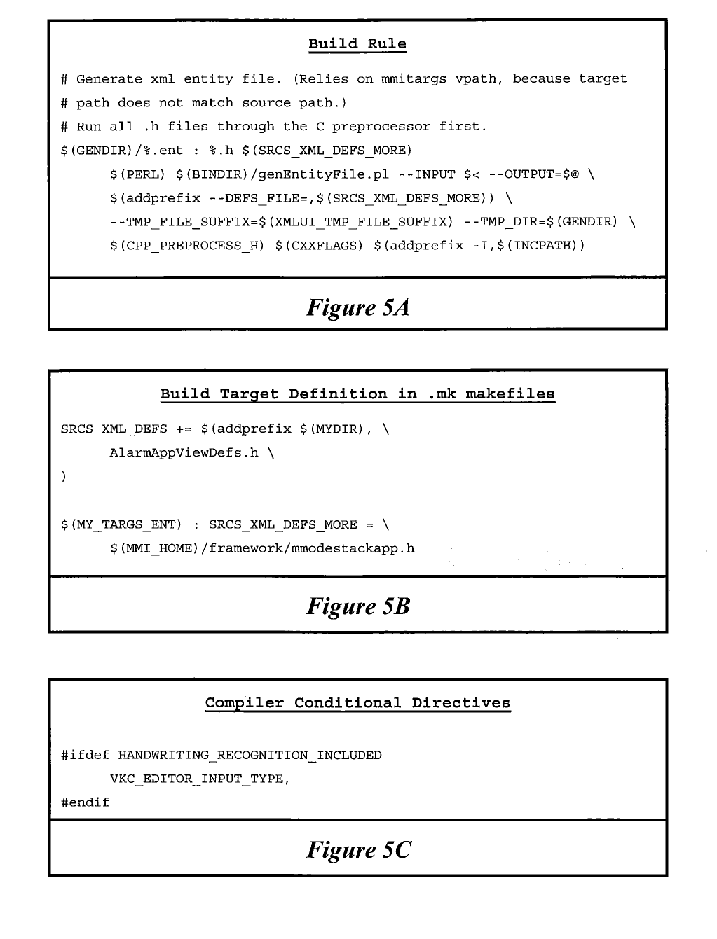

FIG. 5A is an exemplary build rule in accordance with an embodiment of the present invention. This exemplary build rule shows the “make” rule for building the entity files from C++ header files. This defines the relationship between the header files defined under “SRCS_XML_DEFS” in FIG. 5B to be built as an ent file using the genEntityFile.pl build tool.

FIG. 5B is an exemplary build target definition in accordance with an embodiment of the present invention. The exemplary build target shows how a C++ header file is identified as a source file for the entity generation build. In this example, target-specific variable assignment with MY_TARGS_ENT is used in order to support a non-recursive makefile. A non-recursive makefile may be faster than a recursive makefile, especially for processing XML files that exists in many different application directories. One benefit of keeping the source XML files in the various application directories, rather than in a central location, is that it more easily allows entire applications to be conditionally excluded from the build.

SRCS_XML_DEFS contains a list of source header files from which to generate entity files. The base name of the file may be used for the generated entity file name (i.e. AlarmAppViewDefs.h generates AlarmAppViewDefs.ent).

SRCS_XML_DEFS_MORE defines a list of files that the source files need to include during entity generation, in order to resolve dependencies and provide additional definitions. For example, the source file's enumerations might refer to the enumeration value
MModeStackApp::MARKER_START_APP_DEFINED
   in mmodestackapp.h, in order to define a new entity:

MARKER CUSTOM=(MModeStackApp::MARKER_START_APP_DEFINED<<0)

The genEntityFile.pl tool in FIG. 5A can resolve this entity using the mmodestackapp.h include file.

FIG. 5C is an exemplary compiler conditional directive in accordance with an embodiment of the present invention. Compiler conditional directives may be stripped via a C-preprocessor. The C++ header files (both source header files and their include files) are first run through the C-preprocessor to handle compiler conditional directives, like those shown in FIG. 5C. The C-preprocessor may be given the same preprocessor definitions as the normal build (i.e., $(CXXFLAGS) in FIG. 5A), so that the entity values are consistent with the actual enumeration values.

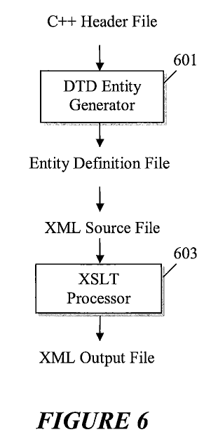

FIG. 6 is a block diagram of a system for assuring data integrity in data-driven software in accordance with an embodiment of the present invention. A C++ Header file may processed by a DTD Entity Generator, 601, to produce an Entity Definition File based on C++ definitions. An XML Source File may include the XML definitions and may depend upon the Entity Definition File. The XML Source File may be processed by an XSLT Processor, 603, to resolve the DTD Entity Definitions, thereby resulting in literal values in a text/string form in an XML Output File.

While the present invention has been described with reference to certain embodiments, it will be understood by those skilled in the art that various changes may be made and equivalents may be substituted without departing from the scope of the present invention.

Additionally, many modifications may be made to adapt a particular situation or material to the teachings of the present invention without departing from its scope. For example, although the invention has been described with a particular emphasis on particular programming languages, the invention can be applied to a wide variety of languages.

Therefore, it is intended that the present invention not be limited to the particular embodiment disclosed, but that the present invention will include all embodiments falling within the scope of the appended claims.

1. A method for developing data-driven software, said method comprising:
converting an enumeration value into an entity;
using the entity in a source code file; and
processing the source code file, thereby producing a string of literal values in a data-driven software file.

2. The method of claim 1, wherein the enumeration value is included in a header file.

3. The method of claim 2, wherein the header file is a C++ header file.

4. The method of claim 1, wherein the entity is an XML entity.

5. The method of claim 1, wherein the source code file is an XML source code file.

6. The method of claim 1, wherein the processing comprises parsing.

7. The method of claim 1, wherein the data-driven software file is an XML data-driven software file.

8. The method of claim 1, wherein using the entity comprises referring to the entity.

9. The method of claim 1, wherein using the entity comprises including the entity.

10. A system for developing data-driven software, said system comprising:
an entity generator for converting an enumeration value into an entity; and
a processor for processing a source code file, wherein the source code file refers to the entity, thereby producing a string of literal values in a data-driven software file.

11. The system of claim 10, wherein the enumeration value is included in a header file.

12. The system of claim 11, wherein the header file is a C++ header file.

13. The system of claim 10, wherein the entity is an XML entity.

14. The system of claim 10, wherein the source code file is an XML source code file.

15. The system of claim 10, wherein the processor is a parser.

16. The system of claim 10, wherein the processor is an XSLT processor.

17. The system of claim 10, wherein the entity generator is a DTD entity processor.

18. The system of claim 10, wherein the data-driven software file is an XML data-driven software file.

19. The system of claim 10, wherein the entity is included in the source code file.

20. The system of claim 10, wherein a dependency is created between the entity and the enumeration value.

21. The system of claim 20, wherein the dependency is automatically extracted and maintained.

22. The system of claim 20, wherein the enumeration value is in a C++ header file.

23. The system of claim 10, wherein a dependency is created between the source code file and the entity.

24. The system of claim 23, wherein the dependency is automatically extracted and maintained.

25. The system of claim 23, wherein the source code file is an XML source.
